(19) United States
(12) Patent Application Publication
(10) Pub. No.: US 2006/0088237 A1
(43) Pub. Date: Apr. 27, 2006

(54) Thrust needle roller bearing

(76) Inventors: Kazuyuki Yamamoto, Iwata-shi (JP); Kousuke Obayashi, Iwata-shi (JP)

Correspondence Address: HARNESS, DICKEY & PIERCE, P.L.C., P.O. BOX 828, BLOOMFIELD HILLS, MI, 48303, US

(21) Appl. No.: 11/257,467

(22) Filed: Oct. 24, 2005

(30) Foreign Application Priority Data
Oct. 26, 2004 (JP) 2004-310713

(51) Int. Cl. F16C 33/46

(52) U.S. Cl. 384/623

(57) ABSTRACT

A double row thrust needle roller bearing, which can suppress differential slippage of the needle rollers under severe working conditions to improve its durability without increasing processing cost for majority variety/minority lot production, has a plurality of needle rollers (2) arranged in at least two rows in a radial direction and an annular cage (3) formed with a plurality of pockets (4) to hold the needle rollers (2). Each pocket (4) is formed in a rectangular configuration with a length of its radial side longer than that of each needle roller (2). A length of the pockets circumferential side is larger than the diameter of each needle roller (2). Each needle roller (2) is held within each pocket (4) of the cage (3) by nailed portions (5). The nailed portions (5) are formed near radially extending side walls (4a) of the pockets (4) at either sides of each needle roller (2) along its longitudinal direction. The nailed portions (5) are formed by plastically deforming the cage (3) at a substantially middle portion of the longitudinal length of the needle roller (2). Thus, each nailed portion (5) overhangs into the pocket (4) over the needle roller (2).

### CROSS-REFERENCE TO RELATED APPLICATION

This application claims priority to Japanese Patent Application No. 2004-310713, filed Oct. 26, 2004, which application is herein expressly incorporated by reference.

### FIELD OF THE INVENTION

The present invention relates to a double row thrust needle roller bearings used in automatic transmissions, compressors for vehicle air conditioner, continuously variable transmissions, electric brakes and the like. Although “a needle roller” is classified in Japanese Industrial Standards (JIS) as “a cylindrical roller having a diameter less than 5 mm and a ratio of length/diameter of 3˜10”, the term “needle roller”, used herein, has a broader meaning without being limited to the definition of JIS. In other word, it should be appreciated that the term “needle roller” in this specification includes both “long cylindrical roller” and “cylindrical roller” defined in JIS.

### BACKGROUND OF THE INVENTION

The thrust needle roller bearing includes needle rollers, a cage and bearing ring(s). It has a structure of line contact between the needle roller and the bearing ring. It has an advantage that it exhibits high loading capacity as well as high rigidity despite of its small projected area. This is a reason that it is widely used as a thrust-load supporting part in mechanical apparatus such as automatic transmissions, air compressors for vehicle air conditioners, continuously variable transmissions, electric brakes and the like. In these industrial fields, the needle roller bearing is obliged to be used under severe conditions such as lean lubrication and high rotational speeds in order to pursue a light weight and small size bearing. Accordingly, the present applicant has proposed a prior art double row thrust needle roller bearing as shown in FIG. 12.

The double row thrust needle roller bearing 51 has a plurality of needle rollers 52. Two annular cages 53 and 54 hold the needle rollers 52 at a predetermined pitch in the circumferential direction. The cages 53 and 54 are made of cold rolled steel plate (e.g. JIS SPC etc.) by press-forming. The cages 53 and 54 are formed with a plurality of rectangular pockets 55 and 56. Each pocket has a radial (longitudinal) length longer than the length “L” of the needle roller 52. Oppositely projecting roller holding portions 55a and 56a are formed on either longitudinal edges of each pocket 55 and 56 to hold the needle rollers 52 while sandwiching them in the thickness direction.

The needle rollers 52 include radially outer needle rollers 52a and radially inner needle rollers 52b. The outer and inner rollers 52a and 52b are arranged in a double row manner within the pockets 55 and 56. The double row arrangement enables the bearing to reduce the revolution velocity difference between outer and inner portions of the needle rollers. Thus, this reduces their slippage relative to the bearing rings (not shown). Accordingly, heat generation in the contacting portions is reduced. Also, surface damages and surface peeling are prevented.

As shown in FIG. 12 (d), the radial length “La” of the roller holding portions 55a and 56a is shorter than the longitudinal length “L” of the needle rollers 52. Thus, recesses 55b and 56b, formed at either sides of the roller holding portions 55a and 56a, enables lubrication oil to easily pass therethrough.

As shown in FIG. 12(c), either side of the roller holding portion 55a of the upper cage 53 is formed by inclined portions 53a and 53c, folded at either ends of the roller holding portion 55a, and by outer and inner flat portions 53b and 53d, folded at the ends of the inclined portions 53a and 53c. Similarly, inclined portions 54a and 54c as well as outer and inner flat portions 54b and 54d are formed on the lower cage 54.

The two cages 53 and 54 are laid one on top of the other and united by folding the radially outermost edge of the outer flat portion 54b upward, to form a caulked portion 57, and by folding the radially innermost edge of the inner flat portion 53d downward, to form a caulked portion 58. Thus, the two cages 53 and 54 are securely united by the caulked portions 57 and 58. Thus, they should not be separated during operation of the bearing.

In a condition in which two cages 53 and 54 are securely united, the thickness “T0” of the roller holding portions 55a and 56a is larger than the thickness “T1” and “T2” of the radially outer and inner flat portions.

The double row thrust roller bearing with its two cages 53 and 54 improves flow-in/flow-out ability of lubricant and thus prevent seizure of the bearing. Also, the durability of the bearing can be improved (see Japanese Laid-open Patent Publication No. 36849/2004).

While the double row thrust needle roller bearing of the prior art has the above mentioned advantages and is suitable for the minority variety/majority lot production, it is not suitable for the majority variety/minority lot production required to satisfy a recent trend of diversification of needs. This is due to the increase cost of manufacturing due to the increase of a ratio of die manufacturing cost etc. relative to processing cost.

### SUMMARY OF THE INVENTION

It is, therefore, an object of the present invention to provide a double row thrust needle roller bearing which can suppress the differential slippage of the needle rollers under severe working conditions and improve its durability without increasing the processing cost for the majority variety/minority lot production.

According to the present invention, a double row thrust needle roller bearing comprises a plurality of needle rollers arranged with at least two rows in a radial direction. An annular cage is formed with a plurality of pockets to hold the needle rollers. Each pocket is formed as a rectangular configuration with a length of its radial side longer than that of each needle roller. A length of the pocket's circumferential side is larger than the diameter of each needle roller. Each needle roller is held within each pocket of the cage by nailed portions. The portions are formed near the radially extending side walls of the pockets at either side of each needle roller along its longitudinal direction by plastically deforming the cage at a substantially middle portion of the longitudinal length of the needle roller. Thus, each nailed portion overhangs into the pocket over the needle roller.

According to the present invention, due to the double row thrust needle roller bearing having a plurality of needle rollers arranged with at least two rows in a radial direction, and an annular cage formed with a plurality of pockets to hold the needle rollers with each pocket formed as a rectangular configuration having a length of its radial side longer than that of each needle roller and a length of its circumferential side larger than the diameter of each needle roller, and each needle roller is held within each pocket of the cage by nailed portions formed near the radially extending side walls of the pockets at either side of each needle roller along its longitudinal direction by plastically deforming the cage at a substantially middle portion of the longitudinal length of the needle roller so that each nailed portion overhangs into the pocket over the needle roller, the revolution velocity difference is reduced between the radially outer and inner portions of the needle rollers. Thus, it is possible to suppress the slippage of the needle rollers against the bearing ring surface. This reduces the heat generated at the contact portions between the structural elements so that surface damage and surface peeling are prevented. Accordingly, it is possible to provide a double row thrust needle roller bearing which can suppress the differential slippage of the needle rollers under severe working conditions and improve its durability without increasing the processing cost for the majority variety/minority lot production.

Preferably, the cage may be made by cutting soft metal material. This makes it possible to easily form the nailed portions by plastically deforming the soft metal material by using a caulking tool.

In addition, one nailed portion may be formed at one longitudinal side wall of each pocket corresponding to each needle roller. The length of each nailed portion may be set at 60% or more of the length of each needle roller. Two nailed portions may be formed at each longitudinal side wall of the pocket corresponding to each needle roller symmetrically with the other two nailed portions formed at the other longitudinal side wall of each pocket. The length of each nailed portion may be set at 15% or more of the length of each needle roller. In this case, recesses formed between the nailed portions enable the lubrication oil to easily pass therethrough.

A clearance between the needle roller and the pocket in the thickness direction of the cage may be larger than that in the circumferential direction. Accordingly, the needle rollers are firmly guided by the side walls of the pockets not by the inner walls of the nailed portions. Thus, it is possible to stabilize the motion of the needle rollers and to prevent absence of an oil film at the contact portions with the pockets.

According to the present invention, the revolution velocity difference between the radially outer and inner portions of the needle rollers is reduced. Thus, it is possible to suppress the slippage of the needle rollers against the bearing ring surface. This reduces the heat generation in the contact portions between the structural elements so that surface damage and surface peeling are prevented. Accordingly, it is possible to provide a double row thrust needle roller bearing which can suppress the differential slippage of the needle rollers under severe working conditions and improve its durability without increasing the processing cost for the majority variety/minority lot production.

A double row thrust needle roller bearing comprises a plurality of needle rollers arranged with at least two rows in a radial direction. An annular cage is formed with a plurality of pockets to hold the needle roller. Each pocket is formed in a rectangular configuration with a length of its radial side longer than that of each needle roller and a length of its circumferential side larger than the diameter of each needle roller. Each needle roller is held within each pocket of the cage by nailed portions. The nailed portions are formed near radially extending side walls of the pockets at either side of each needle roller along its longitudinal direction by plastically deforming the cage at a substantially middle portion of the longitudinal length of the needle roller. Thus, each nailed portion overhangs into the pocket over the needle roller.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Additional advantages and features of the present invention will become apparent from the subsequent description and the appended claims, taken in conjunction with the accompanying drawings, wherein:

FIG. 1(a) is a plan view of a double row thrust needle roller bearing of a first embodiment of the present invention.

FIG. 1(b) is a cross-sectional view taken along a line Ib-O-Ib of FIG. 1(a).

FIG. 2(a) is a partial enlarged view of FIG. 1(a).

FIG. 2(b) is a similar partial enlarged view of a modified embodiment of FIG. 2(a).

FIG. 3 is a cross-sectional view taken along a line III-III in FIG. 2(a);

FIG. 4(a) is a plan view of a double row thrust needle roller bearing of a second embodiment of the present invention.

FIG. 4(b) is a cross-sectional view taken along a line IVb-O-IVb of FIG. 4(a);

FIG. 5(a) is a partial enlarged view of FIG. 4(a).

FIG. 5(b) is a similar partial enlarged view of a modified embodiment of FIG. 5(a).

FIG. 6 is a cross-sectional view taken along a line VI-VI in FIG. 5(a);

FIG. 7(a) is a plan view of a double row thrust needle roller bearing of a third embodiment of the present invention.

FIG. 7(b) is a plan view of a modified embodiment of FIG. 7(a).

FIG. 8(a) is a plan view of a double row thrust needle roller bearing of a fourth embodiment of the present invention.

FIGS. 8(b) and 8(c) are plan views of modified embodiments of FIG. 8(a).

FIG. 9(a) is a plan view of a double row thrust needle roller bearing of a fifth embodiment of the present invention.

FIGS. 9(b) and 9(c) are plan views of modified embodiments of FIG. 9(a);

FIG. 10(a) is a plan view of a double row thrust needle roller bearing of a sixth embodiment of the present invention.

FIGS. 10(b) and 10(c) are plan views of modified embodiments of FIG. 10(a);

FIG. 11 is a plan view of a double row thrust needle roller bearing of a seventh embodiment of the present invention.

FIG. 12(a) is a plan view of a double row thrust needle roller bearing of the prior art.

FIG. 12(b) is a cross-sectional view taken along a line XIIb-O-XIIb in FIG. 12(a).

FIG. 12(c) is a partial enlarged view of FIG. 12(b).

FIG. 12(d) is a partial enlarged view of a pocket portion.

FIG. 12(e) is an enlarged cross-sectional view taken along a line XIIe-XIIe in FIG. 12(b).

### DETAILED DESCRIPTION OF THE PREFERRED EMBODIMENTS

The following description of the preferred embodiment(s) is merely exemplary in nature and is in no way intended to limit the invention, its application, or uses.

A preferred embodiment of the present invention will be hereinafter described with reference to accompanied drawings.

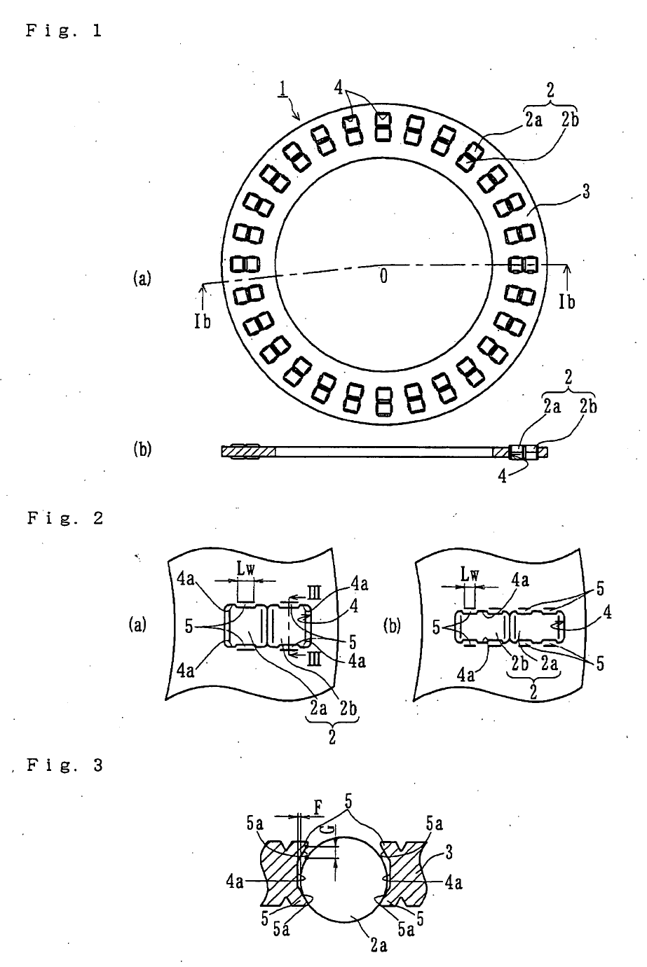

FIG. 1(a) is a plan view of a double row thrust needle roller bearing of a first embodiment of the present invention. FIG. 1(b) is a cross-sectional view taken along a line Ib-O-Ib in FIG. 1(a). FIG. 2(a) is a partial enlarged view of FIG. 1(a). FIG. 2(b) is a similar partial enlarged view of a modified embodiment of FIG. 2(a). FIG. 3 is a cross-sectional view taken along a line III-III in FIG. 2(a).

The double row thrust needle roller bearing 1 includes a plurality of needle rollers 2, and a cage 3 to hold the needle rollers 2 at a predetermined pitch in the circumferential direction. The cage 3 is made by cutting soft metal materials such as copper alloy; some examples are high tensile brass casting (JIS CAC 3 etc.), aluminum/bronze casting (JIS CAC 7 etc.), aluminum, aluminum alloy, or aluminum alloy casting. The cage 3 has a plurality of pockets 4 each formed as a rectangular configuration. Each pocket 4 has a length of its longitudinal (radial) side longer than that of each needle roller 2 and a length of its circumferential side larger than the diameter of each needle roller 2. The pockets 4 may be formed by stamping other than cutting.

The needle rollers 2 comprise radially outer and inner needle rollers 2a and 2b and are arranged within pockets 4 in a double row arrangement. The revolution velocity difference between the radially outer and inner needle rollers can be reduced by the double row arrangement of the needle rollers. Thus, slippage of each needle roller against a bearing ring surface (not shown) is suppressed. Accordingly, heat generated at the contacting portions is reduced and surface damages and surface peeling are also prevented. Although it is shown that radially outer needle rollers 2a and radially inner needle rollers 2b have the same length as each other, it is possible to make the length of the radially outer needle rollers longer than that of the radially inner needle roller. This increases the load supporting capacity of the radially outer needle rollers. Also, although it is shown that the end face of each needle roller 2a and 2b has a flat configuration (so-called “F” end face), other configurations e.g. spherical configuration (so-called “A” end face) or combination of “F” and “A” end faces may be used.

As shown in FIG. 2(a), a plurality of needle rollers 2a and 2b are held within the pockets 4. The needle rollers 2a and 2b are prevented from falling out of the pockets 4 by nailed portions 5. The nailed portions 5 are formed near longitudinal (radially extending) side walls 4a of the pockets 4 at either side of each needle roller 2a and 2b along its longitudinal direction. The nail portions 5 are plastically deformed in the cage 3 by using a caulking tool, such as a punch. The nailed portions 5 are formed at substantially a middle portion of the longitudinal length of the needle roller 2. Thus, each nailed portion 5 overhangs into the pocket 4 over the needle roller 2. If the length “Lw” is less than 60% of that of the needle roller 2a and 2b, it is believed that the needle roller holding force, especially a force for limiting skewing of the needle rollers 2a and 2b, is unsatisfactory. Accordingly, it is preferable that the length “Lw” of the nailed portion 5 is set more than 60% of the length of the needle rollers 2a and 2b.

If the length of the needle rollers 2a and 2b is more than 6 mm, two nailed portions 5 are formed at each longitudinal side wall 4a of the pocket 4 corresponding to each needle roller 2. The nailed portions are symmetrically formed with the other two nailed portions 5 formed at the other longitudinal side wall of each pocket 4. Accordingly, recesses formed between the nailed portions 5 enable lubrication oil to easily pass therethrough. In this case, since the strength of the nailed portions 5 would be insufficient if the length “Lw” of the nailed portions 5 is less than 15% of the length of the needle rollers 2a and 2b, it is preferable to set the length of nailed portions 5 at 15% or more of the length “Lw” of the needle rollers 2a and 2b.

Although the length of each needle roller 2a and 2b is larger than 6 mm, two nailed portions 5 (FIG. 2(b)) may be connected to each other and one nailed portion 5 may be provided similar to the embodiment of FIG. 2(a). In this case, however, the length “Lw” of the nailed portion 5 should be set more than 60% of the length of the needle rollers 2a and 2b.

According to the present embodiment, the double row needle rollers 2a and 2b are adapted to be held by the nailed portions 5. The nailed portions 5 are formed by plastically deforming the cage 3, which is manufactured from soft metal material such as high tensile brass casting or aluminum alloy. Thus, each nailed portion 5 overhangs into the pocket 4 over the needle roller 2. Thus, it is possible to provide a double row thrust needle roller bearing where the nailed portions 5 can be easily formed. Accordingly, the needle rollers 2 can be held with a simple structure and can suppress the differential slippage of the needle rollers under severe working conditions to improve its durability without increasing the processing cost for the majority variety/minority lot production.

It is important that the needle rollers 2 should never sink below the surface of the cage 3. Thus, a relationship between the needle roller 2a and the pocket 4 is established so that the needle roller 2a is guided by the longitudinal side walls 4a of the pocket 4, as shown in FIG. 3. That is, a gap “G”, in a thickness direction between the needle roller 2a and the inner surface 5a of the nailed portion 5, is set so that it is larger than a circumferential gap “F” (F<G) between the needle roller 2a and the side wall 4a of the pocket 4. In other word, the gaps between the needle roller 2a and the pocket 4 are set so that the circumferential gap “F” is smaller than the gap “G” in the thickness direction. If the gap relation would be F>G, the needle roller 2a would be guided by the inner surface 5a of the nailed portion 5. Thus, the behavior of the needle roller 2a would become unstable and the problem of an absence of oil film would be generated. The total length of the opposite nailed portions 5, overhanging into the pocket 4, may be suitably selected at any dimension less than the diameter of the needle roller 2a.

In order to achieve extended life of the double row thrust needle roller bearing, it is possible to suppress heat generated at the bearing portion by optimizing the pocket gap to insure oil flow and by defining the motion (degree of freedom) of the needle roller 2a. When the roller guide portion and the roller stopper portion are formed by separate portions, as in the present embodiment, the optimized value of the pocket gap is set within a range of 0.05˜0.25 mm. The term “pocket gap” means a gap between the needle roller 2a and the one roller guide portion of the cage 3. This occurs when the needle roller 2a is contacted with the other roller guide portion of the cage 3 to keep the center of the needle roller 2a corresponding to the center in the thickness (height) direction.

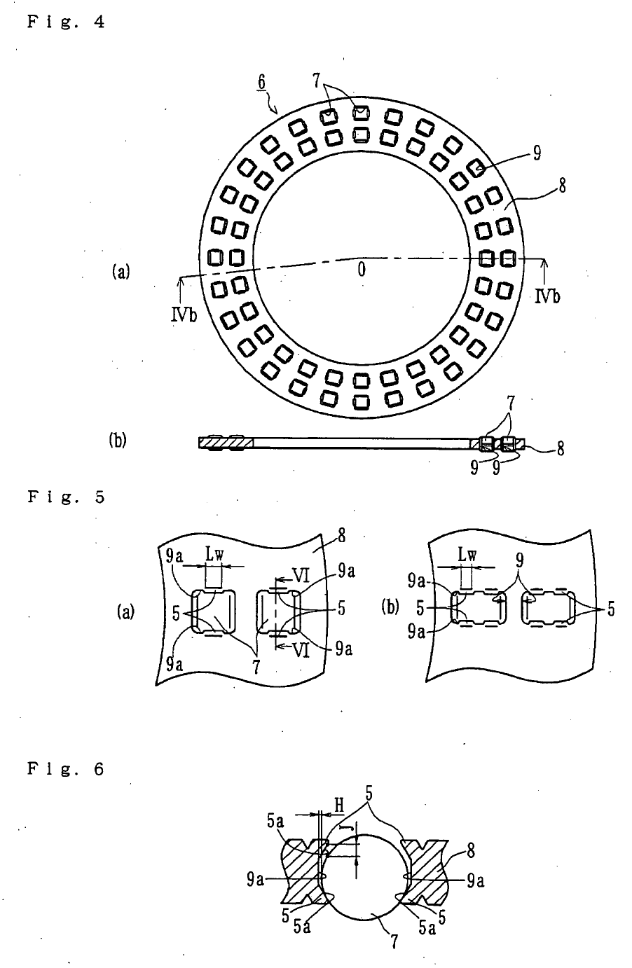

FIG. 4(a) is a plan view of a double row thrust needle roller bearing of a second embodiment of the present invention. FIG. 4(b) is a cross-sectional view taken along a line IVb-O-IVb in FIG. 4(a). FIG. 5(a) is a partial enlarged view of FIG. 4(a). FIG. 5(b) is a similar partial enlarged view of a modified embodiment of FIG. 5(a). FIG. 6 is a cross-sectional view taken along a line VI-VI in FIG. 4(a).

The double row thrust needle roller bearing 6 comprises a plurality of needle rollers 7 and a cage 8 to hold the needle rollers 7 at a predetermined pitch in the circumferential direction. Similar to the first embodiment, the cage 8 is made by cutting soft metal materials such as copper alloy. Some examples are high tensile brass casting (JIS CAC 3 etc.), aluminum/bronze casting (JIS CAC 7 etc.), aluminum, aluminum alloy, or aluminum alloy casting (JIS AC etc.). The cage 8 has a plurality of pockets 9 each formed in a rectangular configuration with a length of its longitudinal (radial) side longer than that of each needle roller 7. A length of the pocket's circumferential side is larger than the diameter of each needle roller 7. The pockets 9 include double rows arranged in the same phase in a radially outer and inner directions.

As shown in FIG. 5(a), the needle roller 7 contained within each pocket 9 is held therein and prevented from falling out by nailed portion 5. The nailed portion 5 is formed near the longitudinal side walls 9a of the pockets 9 at either side of each needle roller 7 along its longitudinal direction. The nailed portion 5 is formed by plastically deforming the cage 8 by a caulking tool, such as a punch, at a substantially middle portion of the longitudinal length of the needle roller 7. Thus, each nailed portion 5 overhangs into the pocket 9 over the needle roller 7. The length “Lw” of the nailed portion 5 is set more than 60% of the length of the needle roller 7.

If the length of the needle roller 7 is more than 6 mm, two nailed portions 5 are formed at each longitudinal side wall 9a of the pocket 9 corresponding to each needle roller 2. The nailed portions 5 are symmetrically formed with the other two nailed portions 5 formed at the other longitudinal side wall of each pocket 9. The length “Lw” of the nailed portions 5 is set less than 15% of the length of the needle rollers 7. Although the length of each needle roller 7 is larger than 6 mm, two nailed portions 5 (FIG. 5(b)) may be connected to each other and one nailed portion 5 may be provided similar to the embodiment of FIG. 5(a). In this case, however, the length “Lw” of the nailed portion 5 should be set at more than 60% of the length of the needle rollers 7.

Also according to the second embodiment, the double row needle rollers 7 are adapted to be held by the nailed portions 5. The nailed portions 5 are formed by plastically deforming the cage 8, which is manufactured from soft metal material such as high tensile brass casting or aluminum alloy. Thus, each nailed portion 5 overhangs into the pocket 9 over the needle roller 7. Thus, it does not increase the processing cost for the majority variety/minority lot production. Contrary to the first embodiment, since one needle roller 7 is held by one pocket 9 in the second embodiment, it is possible to stably hold the needle roller 7 and to prevent skewing of the needle roller 7. Accordingly, it is possible to provide a double row thrust needle roller bearing which can suppress differential slippage of the needle rollers under severe working conditions to improve its durability.

A dimensional relation between the needle roller 7 and the pocket 9 is established so that the needle roller 7 is guided by the longitudinal side walls 9a of the pocket 9 as shown in FIG. 6. That is, a gap “J”, in a thickness direction between the needle roller 7 and the inner surface 5a of the nailed portion 5, is set so that it is larger than a circumferential gap “H” (H<J) between the needle roller 7 and the side wall 9a of the pocket 9. If the gap relation would be H>J, the needle roller 7 would be guided by the inner surface 5a of the nailed portion 5. Thus, the behavior of the needle roller 7 would become unstable and the problem of an absence of oil film would be generated.

Although the double row thrust needle roller bearing of the present invention has been described with reference to those where the double row needle rollers are arranged in the same phase with each other, it can be applied to one having various needle roller arrangements.

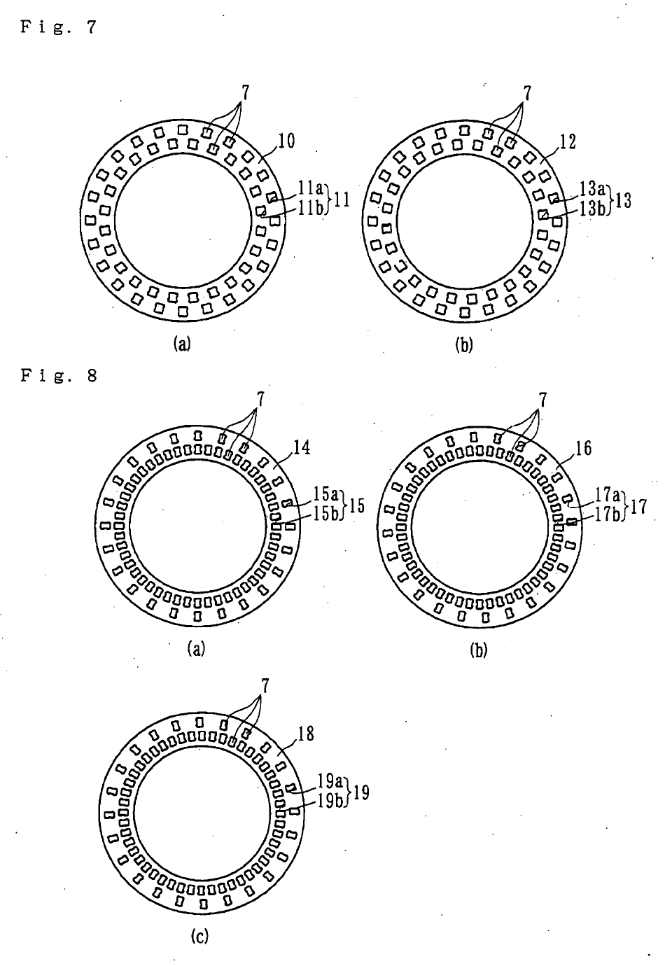

FIG. 7 is a plan view of a double row thrust needle roller bearing of a third embodiment of the present invention. Similar to the second embodiment (FIG. 4), this embodiment has a double row pockets of radially outer and inner rows, respectively, of same number. However, the arrangement of the pockets is different.

The double row thrust needle roller bearing shown in FIG. 7(a) includes a plurality of needle rollers 7 and an annular cage 10 to hold the needle rollers 7 at a predetermined pitch in the circumferential direction. Similar to the previously described embodiments, the cage 10 is made by cutting soft metal materials such as copper alloy. Examples are high tensile brass casting (JIS CAC 3 etc.), aluminum/bronze casting (JIS CAC 7 etc.), aluminum, aluminum alloy, or aluminum alloy casting (JIS AC etc.). The cage 10 has a plurality of pockets 11. Each pocket is formed as a rectangular configuration with a length of its longitudinal (radial) side longer than that of each needle roller 7. A length of the pocket's circumferential side is larger than the diameter of each needle roller 7. The pockets 11 include double row arrangement in which each radially outer pockets 11a is arranged at the middle of adjacent radially inner pockets 11b. Thus, the inner and outer pockets are staggered with respect to one another.

Such an arrangement of the double row radially outer and inner pockets 11a and 11b not only enables an increase of strength of the cage 10 but improves the flow of lubricant.

The radially outer pockets 11a do not necessarily need to be arranged at the middle of the radially inner pockets 11b. They may be arranged as shown in FIG. 7(b). The double row thrust needle roller bearing of FIG. 7(b) includes a plurality of needle rollers 7 and an annular cage 12 to hold the needle rollers 7 at a predetermined pitch in the circumferential direction. Similar to the previously described embodiments, the cage 12 has a plurality of pockets 13. Each pocket is formed as a rectangular configuration with a length of its longitudinal (radial) side longer than the length of each needle roller 7. A length of pocket's circumferential side is larger than the diameter of each needle roller 7. The pockets 13 include a double rows arrangement where each radially outer pocket 13a is arranged between adjacent radially inner pockets 13b. The phase of the radially outer pockets 13a is slightly staggered from the radially inner pockets 13b.

FIG. 8 is a plan view of a double row thrust needle roller bearing of a fourth embodiment of the present invention. Similar to the second and third embodiments (FIGS. 4 and 7), this embodiment has double row pockets of radially outer and inner directions. However, the number of the radially inner pockets is larger than that of the radially outer pockets.

The double row thrust needle roller bearing of FIG. 8(a) includes a plurality of needle rollers 7 and an annular cage 14 to hold the needle rollers 7 at a predetermined pitch in the circumferential direction. The cage 14 has a plurality of pockets 15. Each pocket is formed as a rectangular configuration with a length of its longitudinal (radial) side longer than the length of each needle roller 7. A length of the pocket's circumferential side is larger than the diameter of each needle roller 7. The pockets 15 include a double row arrangement of radially outer and inner pockets 15a and 15b. The number of the radially inner pockets 15b is larger than that of the radially outer pockets 15a. Thus, the bearing can be applied to a place where the radially inner portion of the bearing can support a larger load than the radially outer portion.

A double row thrust needle roller bearing shown in FIG. 8(b) is a modification of the embodiment shown in FIG. 8(a) where a plurality of pockets 17 are formed in the cage 16. The number of the radially inner pockets 17b is larger than the radially outer pockets 17a. The radially outer pockets 17a are arranged so that they have a phase arrangement positioned at the middle of the radially inner pockets 17b.

A double row thrust needle roller bearing shown in FIG. 8(c) is a modification of the embodiment shown in FIG. 8(a) where a plurality of pockets 19 are formed in the cage 18. The number of radially inner pockets 18b is larger than the number of radially outer pockets 18a. The radially outer pockets 19a are arranged in phase arrangement where the radially outer pockets 19a correspond neither to the radially inner pockets 19b nor to the middle of them.

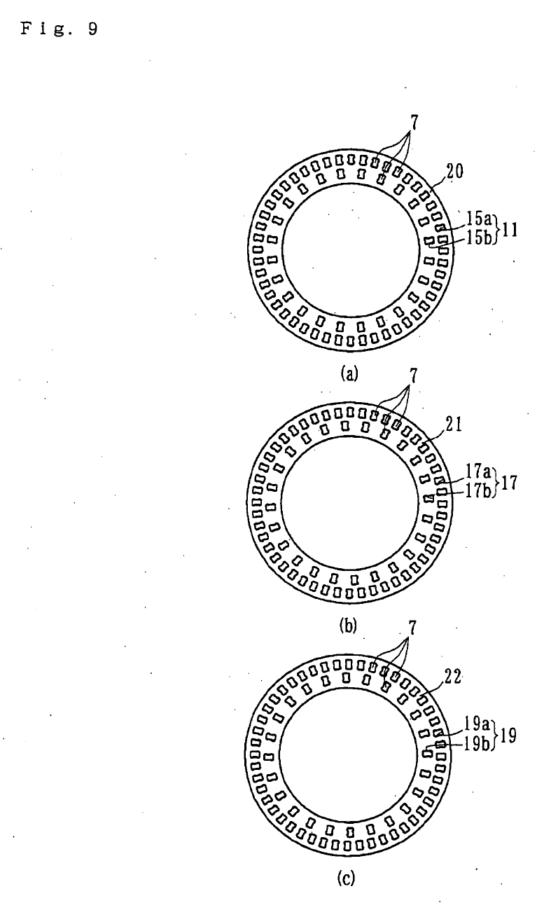

FIG. 9 is a plan view of a double row thrust needle roller bearing of a fifth embodiment of the present invention. Similar to the fourth embodiment (FIG. 8), this embodiment has a double row of pockets of a radially outer and inner direction. However, the number of the radially outer pockets is larger than that of the radially inner pockets.

The double row thrust needle roller bearing of FIG. 9(a) includes a plurality of needle rollers 7 and an annular cage 20 to hold the needle rollers 7 at a predetermined pitch in the circumferential direction. The plurality of pockets 15 include a double row arrangement of radially outer and inner pockets 15a and 15b. The number of the radially outer pockets 15a is larger than the number of radially inner pockets 15b. Thus, the bearing can be applied to a place where the radially outer portion of the bearing can support a larger load than the radially inner portion.

A double row thrust needle roller bearing shown in FIG. 9(b) is a modification of the embodiment shown in FIG. 9(a) where a plurality of pockets 17 are formed in the cage 21. The number of the radially outer pockets 17a is larger than that of the radially inner pockets 17b. The radially outer pockets 17a are arranged so that they have a phase arrangement positioned at the middle of the radially inner pockets 17b.

A double row thrust needle roller bearing shown in FIG. 9(c) is a modification of the embodiment shown in FIG. 9(a) where a plurality of pockets 19 are formed in the cage 22. The number of the radially outer pockets 19a is larger than the number of radially inner pockets 19b. The radially outer pockets 19a are arranged in a phase arrangement where the radially outer pockets 19a correspond neither to the radially inner pockets 19b nor to the middle of them.

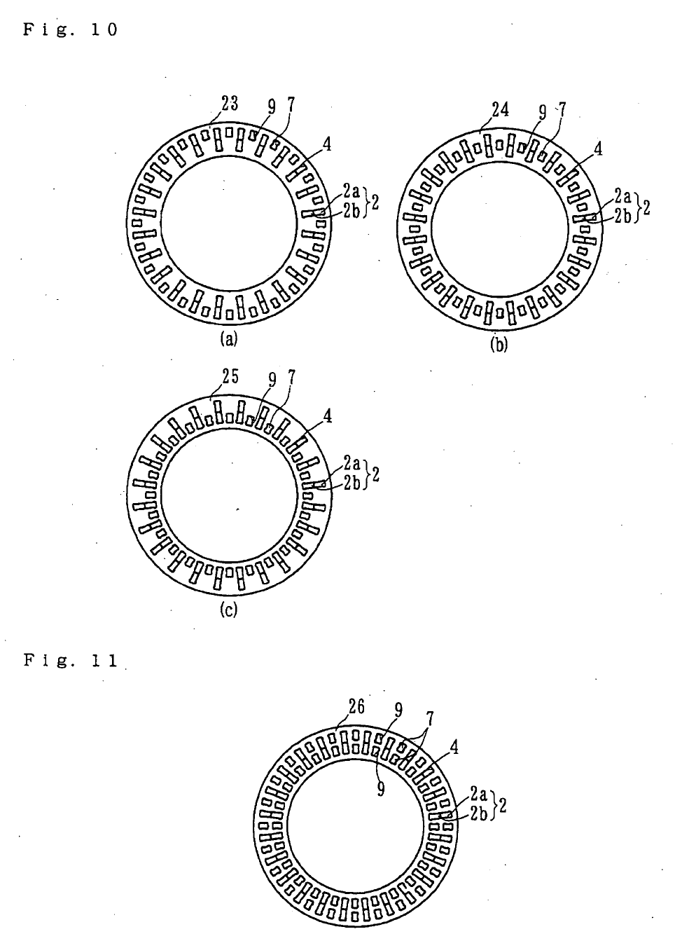

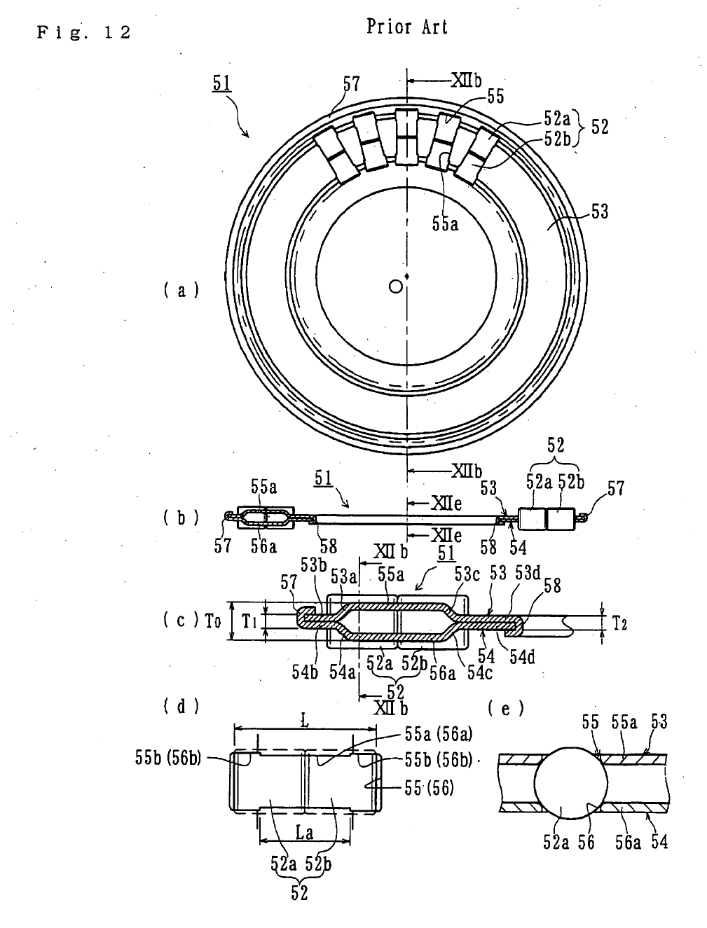

FIG. 10 is a plan view of a double row thrust needle roller bearing of a sixth embodiment of the present invention. This embodiment is a modification of the previously described first embodiment (FIG. 1).

The double row thrust needle roller bearing of FIG. 10(a) includes a plurality of needle rollers 2 and 7 and an annular cage 23 to hold the needle rollers 2 and 7 at a predetermined pitch in the circumferential direction. The cage 23 has a plurality of pockets 4. Each pocket is formed as a rectangular configuration with a length of its longitudinal (radial) side longer than that of the length of the double row needle rollers 2 (including radially outer and inner needle rollers 2a and 2b). A length of the pocket's circumferential side is larger than the diameter of each needle roller 2. Single row pockets 9 to hold needle rollers 7 are between pockets 4 at the radially outer side.

The double row thrust needle roller bearing of FIG. 10(b) is a modification of the embodiment of FIG. 10(a). The bearing includes a plurality of needle rollers 2 and 7 and an annular cage 24 to hold the needle rollers 2 and 7 at a predetermined pitch in the circumferential direction. The cage 24 has pockets 4 for the double row needle rollers 2a and 2b and single row pockets 9. The single row pockets 9 are arranged at substantially the middle of the adjacent pockets 4 to hold the needle rollers 7.

The double row thrust needle roller bearing of FIG. 10(c) is also a modification of the embodiment of FIG. 10(a). The bearing includes a plurality of needle rollers 2 and 7 and an annular cage 25 to hold the needle rollers 2 and 7 at a predetermined pitch in the circumferential direction. The cage 25 has pockets 4 and single row pockets 9 to hold needle rollers 7 between pockets 4 at the radially inner side.

FIG. 11 is a plan view of a double row thrust needle roller bearing of a sixth embodiment of the present invention. This embodiment is a modification of the previously described sixth embodiment (FIG. 10).

This double row thrust needle roller bearing includes a plurality of needle rollers 2 and 7 and an annular cage 26 to hold the needle rollers 2 and 7 at a predetermined pitch in the circumferential direction. The cage 26 has a plurality of pockets 4. Each pocket is formed as a rectangular configuration with a length of its longitudinal (radial) side longer than the length of the double row needle rollers 2 (including radially outer and inner needle rollers 2a and 2b). A length of the pockets circumferential side is larger than the diameter of each needle roller 2. Double row pockets 9 to hold needle rollers 7 are positioned between pockets 4.

According to the double row thrust needle roller bearing of the present invention, the double row needle rollers are adapted to be held by the nailed portions. The nailed portions are formed by plastically deforming the cage of soft metal material, such as high tensile brass casting or aluminum alloy. Thus, each nailed portion overhangs into the pocket over the needle roller. Thus, it is possible to provide a double row thrust needle roller bearing where the nailed portions can be easily formed. Accordingly, the needle rollers can be held with a simple structure. Also, the bearing can suppress differential slippage of the needle rollers under severe working conditions to improve its durability without increasing the processing cost for the majority variety/minority lot production.

The double row thrust needle roller bearing of the present invention can be incorporated into apparatus such as automatic transmissions, compressors of air conditioner, continuously variable transmissions, electric brakes etc. and can be used as a double row thrust needle roller bearing to support the thrust load applied to the apparatus. The bearing is especially suitable for a double row thrust needle roller bearing of majority variety/minority lot production.

The present invention has been described with reference to the preferred embodiments. Obviously, modifications and alternations will occur to those of ordinary skill in the art upon reading and understanding the preceding detailed description. It is intended that the present invention be construed as including all such alternations and modifications insofar as they come within the scope of the appended claims or their equivalents.

What is claimed is:

1. A double row thrust needle roller bearing comprising:
a plurality of needle rollers arranged in at least two rows in a radial direction,
an annular cage formed with a plurality of pockets for holding needle rollers;
each pocket being formed as a rectangular configuration having a length of its radial side longer than that of each needle roller and a length of its circumferential side larger than a diameter of each needle roller;
each needle roller being held within each pocket of the cage by nailed portions formed near radially extending side walls of the pockets at either sides of each needle roller along its longitudinal direction, said nailed portions formed by plastically deforming the cage at a substantially middle portion of the longitudinal length of the needle roller so that each nailed portion overhangs into the pocket over the needle roller.

2. A double row thrust needle roller bearing of claim 1 wherein said cage is made by cutting soft metal material.

3. A double row thrust needle roller bearing of claim 1 wherein said nailed portion includes one portion at one longitudinal side wall of each pocket corresponding to each needle roller, and the length of each nailed portion is set at 60% or more of the length of each needle roller.

4. A double row thrust needle roller bearing of claim 1 wherein two nailed portions are formed at each longitudinal side wall of the pocket corresponding to each needle roller, said two nailed portions are symmetrical with two other nailed portions formed at the other longitudinal side wall of each pocket, and the length of each nailed portion is set at 15% or more of the length of each needle roller.

5. A double row thrust needle roller bearing of claim 1 wherein a clearance gap between the needle roller and the pocket in the thickness direction of the cage is larger than that in the circumferential direction.
